(19) United States
(12) Patent Application Publication
(10) Pub. No.: US 2019/0371144 A1
(43) Pub. Date: Dec. 5, 2019

(54) METHOD AND SYSTEM FOR OBJECT MOTION AND ACTIVITY DETECTION

(71) Applicant: Henry Shu, Walnut, CA (US)

(72) Inventor: Henry Shu, Walnut, CA (US)

(21) Appl. No.: 16/428,889

(22) Filed: May 31, 2019

Related U.S. Application Data
(60) Provisional application No. 62/678,918, filed on May 31, 2018.

(51) Int. Cl. G08B 13/196; G06K 9/00; H04M 1/725; G08B 21/04

(52) U.S. Cl. CPC G08B 13/19613; G08B 21/0476; H04M 1/72536; G06K 9/00335

(57) ABSTRACT

In one aspect, a method for detecting object motion and activity may include steps of receiving an image frame; forming a plurality of subwindows in the image frame; determining one or more subwindows that are in motion; triggering an alarm after determining at least one subwindows that is in motion, wherein the step of determining one or more subwindows that are in motion includes steps of comparing pixel values in each subwindow during a predetermined period of time; determining a dynamic threshold; and determining whether the subwindow is in motion if the pixel value differences exceed the dynamic threshold during the predetermined period of time.

### CROSS-REFERENCE TO RELATED APPLICATIONS

This application claims priority under 35 U.S.C. § 119(e) to U.S. Provisional Patent Application Ser. No. 62/678,918, filed on May 31, 2018, the entire contents of which are hereby incorporated by reference.

### FIELD OF THE INVENTION

The present invention relates to a method and system for object motion and activity detection, and more particularly to a method and system for object motion and activity detection that can be implemented on a mobile electronic device.

### BACKGROUND OF THE INVENTION

Recognizing human actions in real-world environment finds applications in a variety of domains including intelligent video surveillance, customer attributes, and shopping behavior analysis. However, accurate recognition of actions is a highly challenging task due to cluttered backgrounds, occlusions, and viewpoint variations, etc. Therefore, most of the existing approaches make certain assumptions (e.g., small scale and viewpoint changes) about the circumstances under which the video was taken. However, such assumptions seldom hold in real-world environment. In addition, most of these approaches follow the conventional paradigm of pattern recognition, which consists of two steps in which the first step computes complex handcrafted features from raw video frames and the second step learns classifiers based on the obtained features. In real-world scenarios, it is rarely known which features are important for the task at hand, since the choice of feature is highly problem-dependent. Especially for human action recognition, different action classes may appear dramatically different in terms of their appearances and motion patterns.

Deep learning models are a class of machines that can learn a hierarchy of features by building high-level features from low-level ones, thereby automating the process of feature construction. Such learning machines can be trained using either supervised or unsupervised approaches, and the resulting systems have been shown to yield competitive performance in visual object recognition, natural language processing, and audio classification tasks. The convolutional neural networks (CNNs) are a type of deep models in which trainable filters and local neighborhood pooling operations are applied alternatingly on the raw input images, resulting in a hierarchy of increasingly complex features. It has been shown that, when trained with appropriate regularization, CNNs can achieve superior performance on visual object recognition tasks without relying on handcrafted features. In addition, CNNs have been shown to be relatively insensitive to certain variations on the inputs. However, CNNs requires computer hardware with strong computation capabilities which can be very expensive and probably unaffordable for consumers.

Conventionally, a human and/or human activity detection device with Artificial Intelligence (AI)-capable hardware (e.g. NPU, GPU, Intel Movidius chip, or Kneron NPU chip) can be physically integrated into one camera module. The integration of the AI-capable hardware into the camera is costly and entails nontrivial manufacturing overhead. The final product is one single AI-capable camera that may cost several hundreds of US dollars.

Consider an image of width w and height h, in which a plurality of rectangular subwindows can be formed as shown in FIG. 1, and each of the subwindows can be considered just an image smaller than the original one from which it is cropped.

In an object (or activity) detection application, it is important to determine the presence of an object (or activity) and, if indeed it is present, where in the image the object is (or activity happens). The presence of the object (or activity) can be represented as a particular subwindow in which it happens.

Imagine a black box AI engine that can take an input image of any size, and output either YES or NO, where YES means the presence of some target object or activity.

More specifically, a common way to perform object (or activity) detection is to scan the subwindows in an image one by one, and feed each subwindow to the AI engine. Unfortunately, the image can be cut into numerous subwindows, namely the number of subwindows is too large, which makes this process prohibitively slow in practice. However, there are certain heuristics to speed up this process, which include skipping subwindows that sufficiently overlap, processing only subwindows at certain scales or aspect ratios, sharing computation across different invocations of the AI engine, etc. However, as the number of subwindows is simply too large, these speedup heuristics are not sufficient enough to make it amiable for real-time applications.

Therefore, there remains a need for a new and improved image processing technique that can be applies in object motion and/or activity detection to significantly increase computation efficiency, so the object motion or activity detection can be implemented in a mobile electronic device, such as a cellular phone without any assistance from external computation devices with much more powerful computation capability.

### SUMMARY OF THE INVENTION

It is an object of the present invention to provide a method and system for object and object activity detection with high computation efficiency to process real-time video streams.

It is another object of the present invention to provide a method and system for object and object activity detection that can be implemented on a mobile electronic device, such as a cellular phone.

It is still another object of the present invention to provide a method and system for object and object activity detection that can be implemented on a local device, such as a camera.

In one aspect, a method for detecting object motion and activity may include steps of receiving an image frame; forming a plurality of subwindows in the image frame; determining one or more subwindows that are in motion; providing the subwindow(s) in motion to a detecting device to trigger an alarm, wherein the step of determining one or more subwindows that are in motion includes steps of comparing pixel values in each subwindow during a predetermined period of time; determining a dynamic threshold; and determining whether the subwindow is in motion if the pixel value differences exceed the dynamic threshold during the predetermined period of time.

The step of determining one or more subwindows that are in motion further comprises steps of locating one or more discontiguous set of in-motion regions during a predetermined period of time; obtaining a velocity locus for each in-motion region; grouping two or more in-motion regions with similar velocity loci; and enclosing the in-motion regions with similar velocity loci in a circumscribing rectangle.

In another aspect of the present invention, a system for detecting object motion and activity may include an initial image receiver; an image processor; a memory and a user interface. In one embodiment, the image processor is configured to executing instructions to perform steps of forming a plurality of subwindows in the image frame and determining one or more subwindows that are in motion. The memory and user interface may be operatively communicated with the image processor to perform object motion and activity detection. The result of the object motion and activity detection can be outputted through the user interface.

More specifically, the image processor may be configured to generate a plurality of subwindows in an image frame through a subwindow generator; and compare pixel values in each subwindow during a predetermined period of time, determine a dynamic threshold and determine whether the subwindow is in motion if the pixel value differences exceed the dynamic threshold during the predetermined period of time through a computing unit.

The image processor may also be configured to locate one or more discontiguous set of in-motion regions during a predetermined period of time, obtain a velocity locus for each in-motion region through a velocity locus generating unit, group two or more in-motion regions with similar velocity loci; and enclose the in-motion regions with similar velocity loci in a circumscribing rectangle.

It is important to note that the initial image receiver; the image processor; the memory and the user interface can be all integrated into a mobile electronic device, such as a cellular phone. In another embodiment, the system may include a plurality of initial image receivers that can be operated individually and are configured to transmit image frames to the image processor to analyze either through wire or wireless connections.

### BRIEF DESCRIPTION OF THE DRAWINGS

FIG. 1 is a schematic view of forming subwindows in an image frame in the present invention.

FIG. 2 is an image for illustrating a background without moving objects

FIG. 3 illustrates a schematic view of background noise of non-moving objects after preliminary image processing.

FIGS. 4a and 4b illustrate a schematic view of two consecutive image frames, the one at time t+1 moving away from the one at time t.

FIG. 5 illustrates a schematic view of the two consecutive image frames in FIGS. 4a and 4b after image processing to generate discontinuous in-motion regions in the image frame the present invention.

FIG. 6 illustrates a schematic view of a plurality of discontinuous in-motion regions in the image frame in the present invention.

FIG. 7 illustrates a schematic view of velocity loci of in-motion region D in the image frame in the present invention.

FIG. 8 illustrates a schematic view of velocity loci of all in-motion regions in the image frame in the present invention.

FIG. 9 illustrates a schematic view of enclosing in-motion regions B, D and F with similar velocity loci in the image frame in the present invention.

FIG. 10 is an image with a walking person in the background of FIG. 2.

FIG. 11 is a schematic view of identifying the walking person in FIG. 10 with low background noise after image processing in the present invention.

FIG. 12 is a flow diagram of a method for detecting object motion and activity in the present invention.

FIG. 13 is a flow diagram of further steps for determining one or more subwindows that are in motion.

FIG. 14 depicts another aspect of the present invention, illustrating a system for detecting object motion and activity.

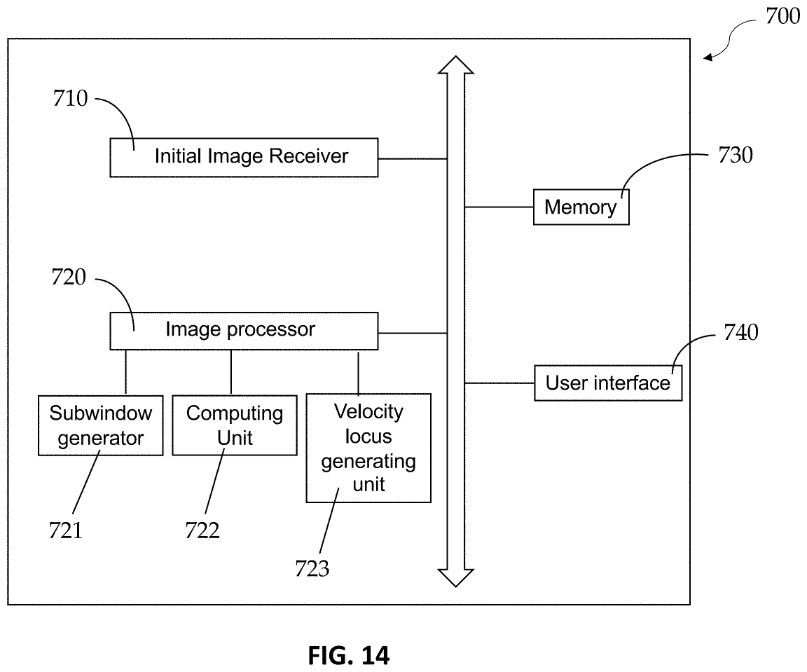

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

As stated above, a common way to perform object (or activity) detection is to scan the subwindows in an image one by one, and feed each subwindow to the AI engine. Unfortunately, the image can be cut into numerous subwindows, namely the number of subwindows is too large, which makes this process prohibitively slow in real-time practice, usually 20-30 fps (frames per second).

Oftentimes, the object or activity to detect only happens when in motion. For example, intruder detection, human fall detection, vehicle detection, etc., are relevant only when the target object is moving. If the number of subwindows can be reduced to what encompasses the objects in motion, and the AI engine can only process these subwindows with objects in motion, a dramatic speedup in the overall detection task can be achieved. An object-in-motion subwindow can be denoted as a region of interest, or ROI.

In digital imaging, a pixel is a physical point in a raster image, or the smallest addressable element in an all points addressable display device; so it is the smallest controllable element of a picture represented on the screen. Each pixel is a sample of an original image; more samples typically provide more accurate representations of the original. The intensity of each pixel is variable and a pixel value can be assigned to each pixel. In color imaging systems, a color is typically represented by three or four component intensities such as red, green, and blue, or cyan, magenta, yellow, and black.

Fundamentally, to check whether a small patch of pixels is part of some entity that is currently moving, we compare that patch of pixels from the current frame to a previous frame. If there are sufficient differences in the pixel values, we can label that patch as “in motion”, otherwise, we label it as “stationary,” which can be done for all the patches that constitute the image, and those patches that are “in motion” may include the ROIs.

Then the next issue may come up, which is “how much pixel value difference must be present between a past patch and the corresponding present patch to designate it as “in motion?” Apparently, setting the threshold too low or too high will severely impact the quality and shape of the ROI, which impacts the ultimate AI engine detection task.

However, it turns out that an optimal threshold for one situation might not work in another situation. For instance, experimentally a good threshold for backyard at dawn yields horrible ROI's for an indoor bedroom scene with LED lighting. Thus, a dynamic thresholding technique should be applied.

An image may include a tiling of a plurality of patches, and for each patch we calculate the overall pixel value difference value in the patch. So, if for example there are 10000 patches in the image, 10000 patch difference values would be obtained and a clustering algorithm can be used to process the values.

In one embodiment, a K-means clustering is used to process the values, where the number of cluster is set to two. Thus, any patch belonging to the lower-value cluster is designated “stationary” and shown in black, whereas any patch belonging to the higher-value cluster is designated “in motion” and shown in white.

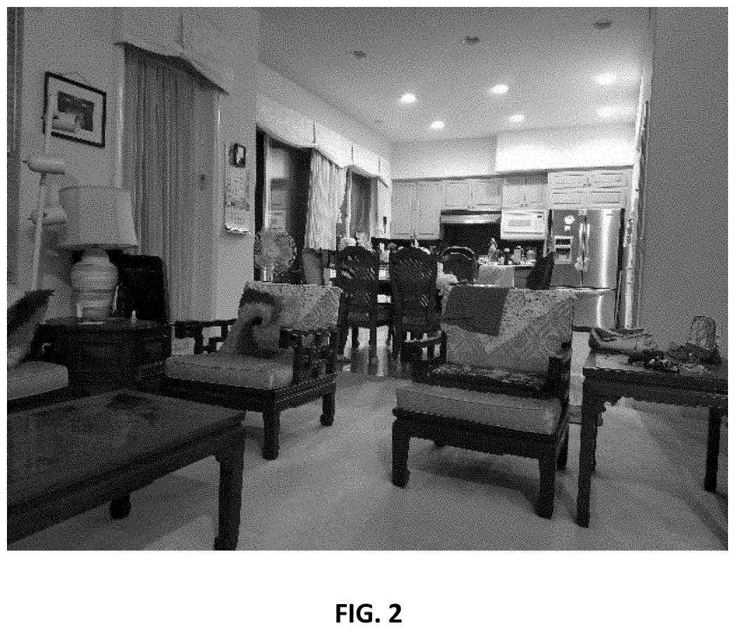

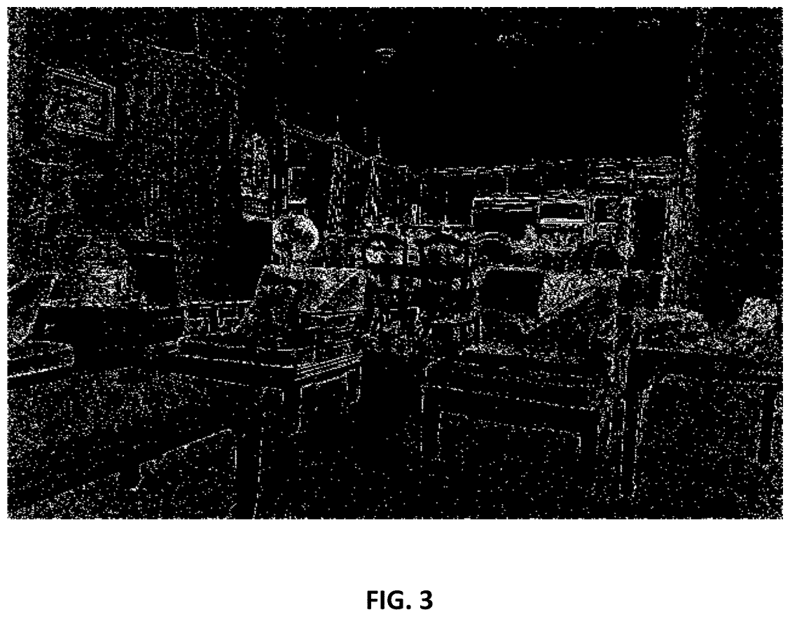

FIG. 2 shows a living room with no moving object, however, applying the techniques discussed above, a somewhat frustrated result may be obtained as shown in FIG. 3, in which even a completely stationary scene has plenty of areas shown in white that are considered “in motion” in the image processing technique in the present invention. Thus, this background noise has to be eliminated by “smoothing” the image. It is noted that the “image” used for example here is not limited to “images.” The detection system in the present invention can be definitely used in a series of images, namely a video stream.

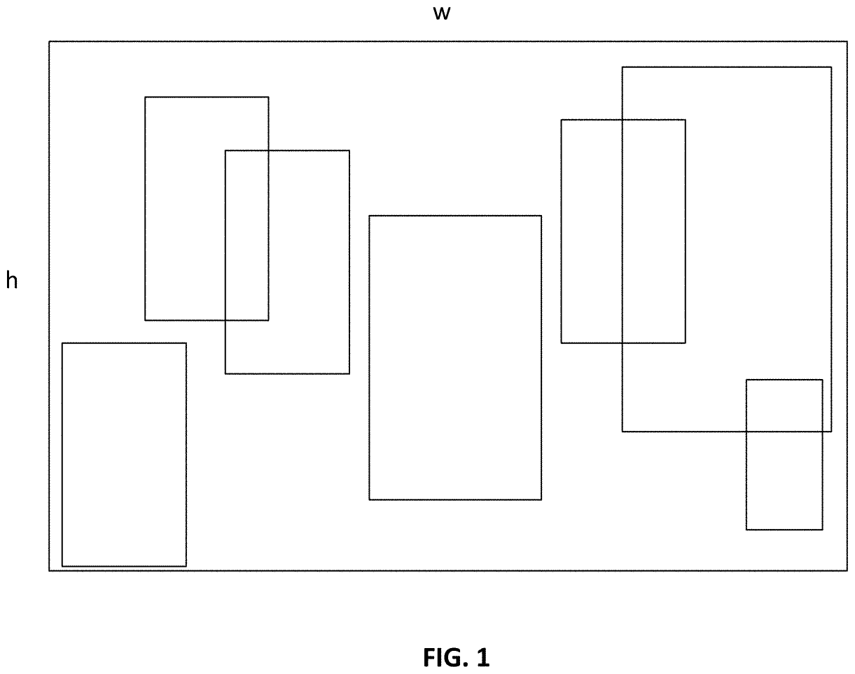

To reduce background noise, consider again a patch as in FIG. 1. The patch as a whole can be determined whether it is “in motion” or “stationary” by invoking a majority vote. That is, for each pixel inside the patch, whether the pixel is “in motion” or “stationary” should be determined again. Then, the whole image can be considered “in motion” if the number of “in motion” pixels in the patches exceed a given threshold. It is noted that the dynamic thresholding technique discussed above can be used to find this threshold.

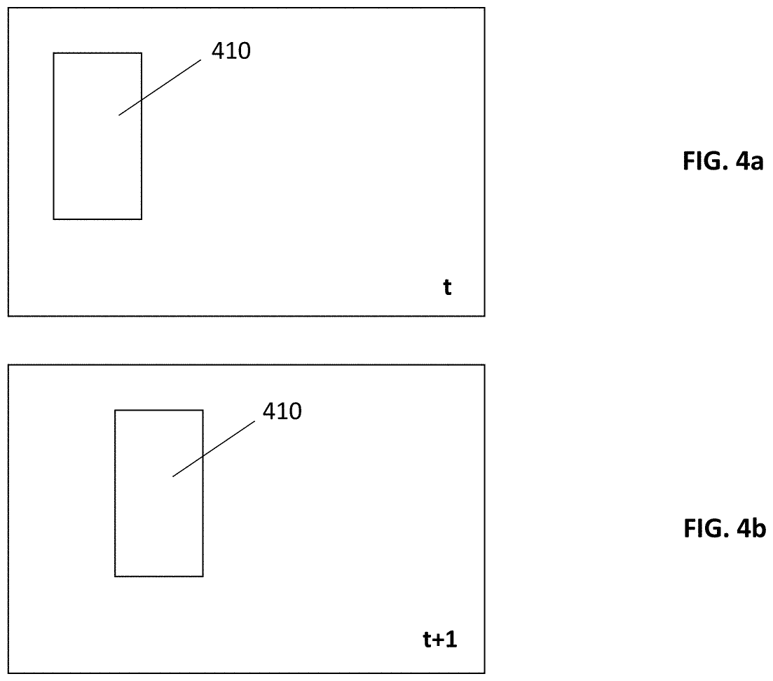

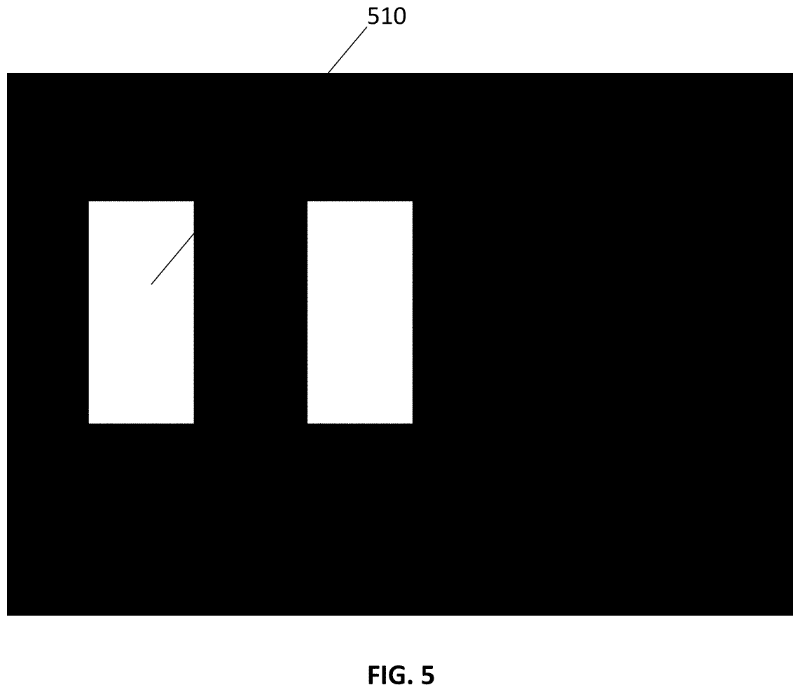

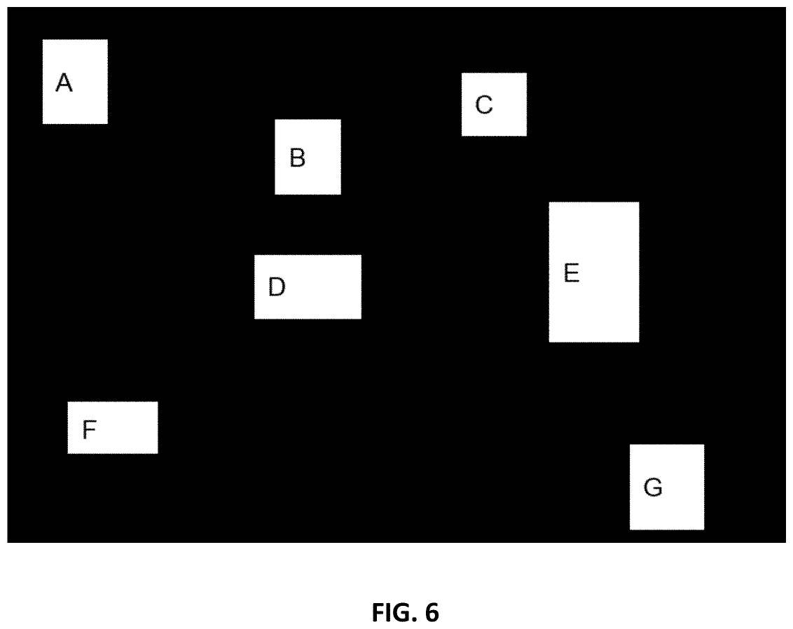

Consider two consecutive frames, one at time t and the other at time t+1, as shown in FIGS. 4a and 4b respectfully and assuming that a white square object is moving. If we simply consider these in-motion patches (where the pixels between two frames differ sufficiently) between frames t and t+1 as described, a discontiguous set 510 of in-motion region is obtained as shown in FIG. 5. However, in real life, things may get messier. For example, in FIG. 6, given a set of in-motion regions, it is difficult to tell which belong to the same moving object.

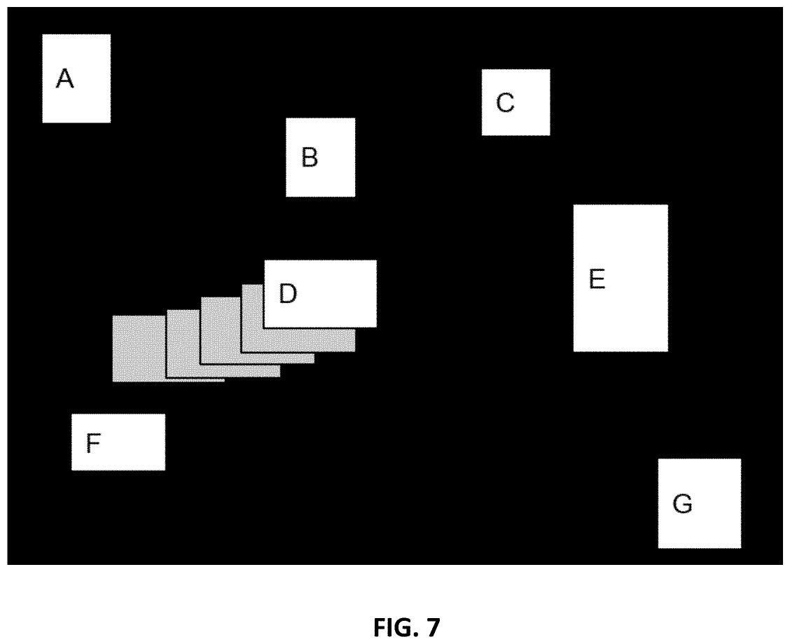

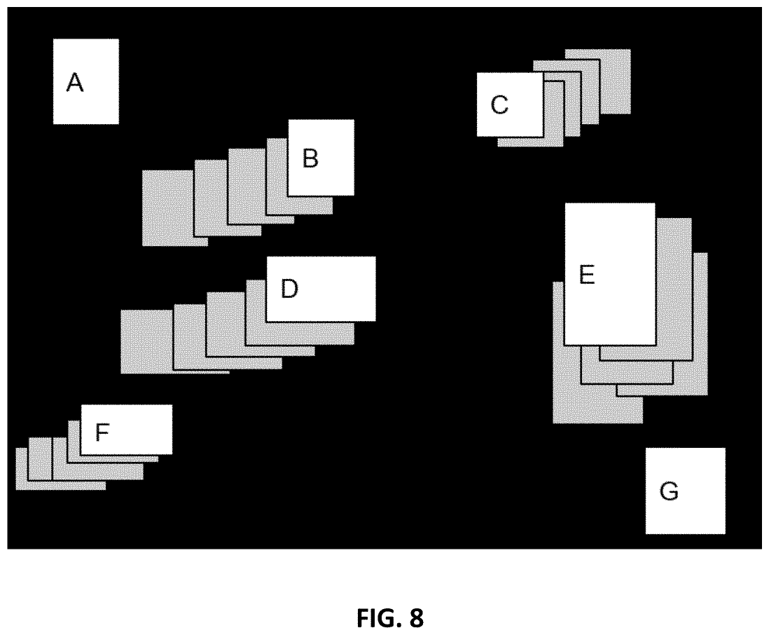

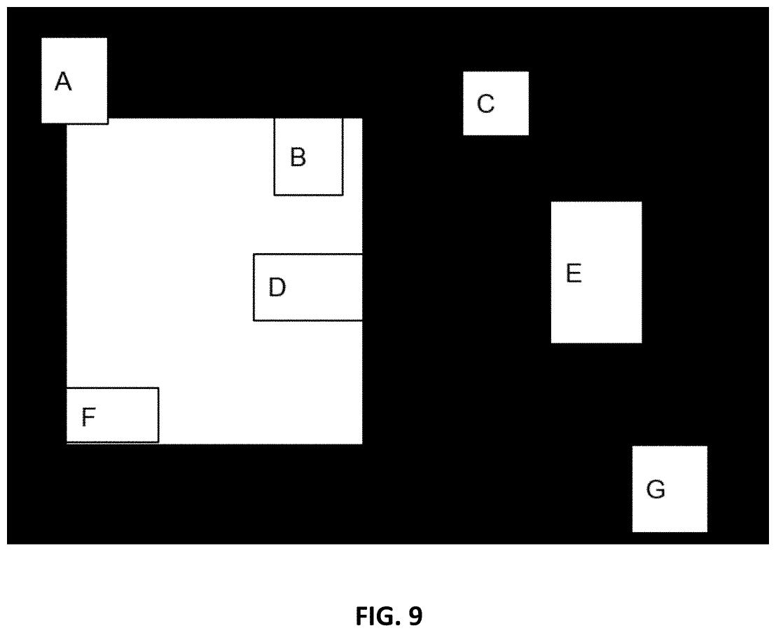

To determine which in-motion regions belong to the same moving object, a velocity locus for each in-motion region is introduced. As shown in FIG. 7, a velocity locus for past four frames for in-motion region D can be obtained. Likewise, the velocity locus for each in-motion region can be obtained as shown in FIG. 8. From the velocity locus for each in-motion region, we may conclude that the in-motion regions with similar velocity loci may belong to the same moving object. For example, as shown in FIG. 8, regions B, D and F have similar velocity loci so they can be grouped by enclosing them with a circumscribing rectangle, as shown in FIG. 9. In other words, we replace regions B, D, and F with their circumscribing rectangle, which can be the moving object regions B, D and F belong to. The circumscribing rectangle is most likely the ROI which can be fed the AI detection device so the computation efficiency for the AI device can be significantly increased because the region of ROI is a much smaller subset comparing with the entire image frame.

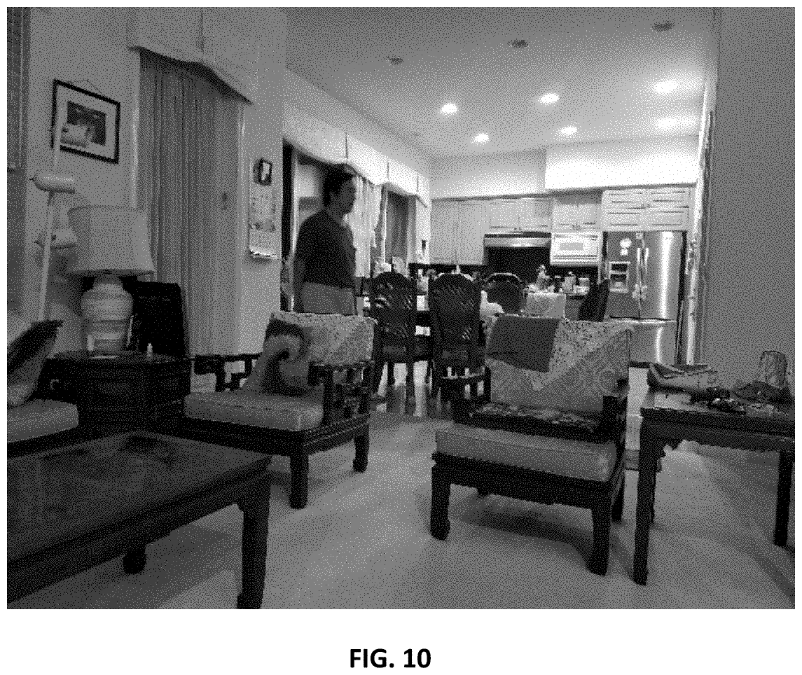

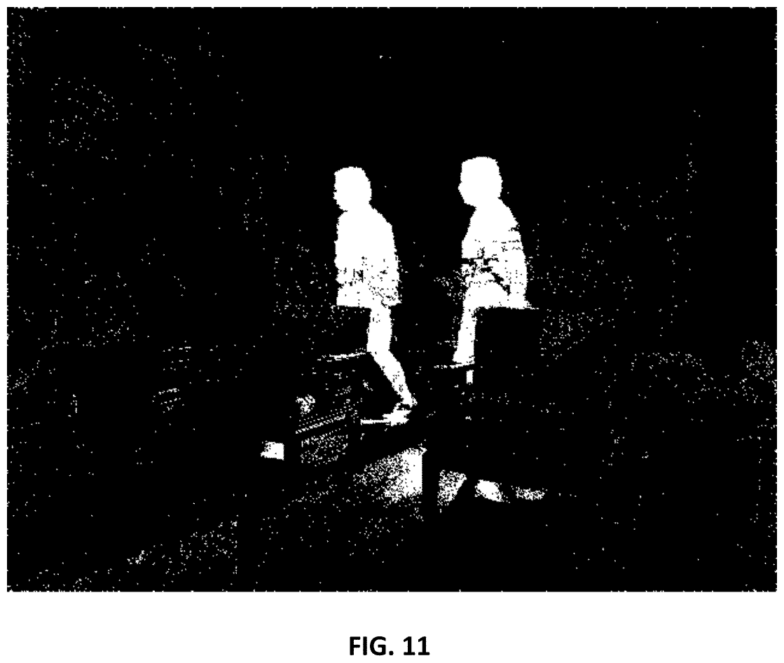

FIG. 10 shows the living room (the same as FIG. 2) with a person walking therein. With an optimally tune threshold and image processing techniques discussed above, a region of interest (ROI) can be easily located as shown in FIG. 11.

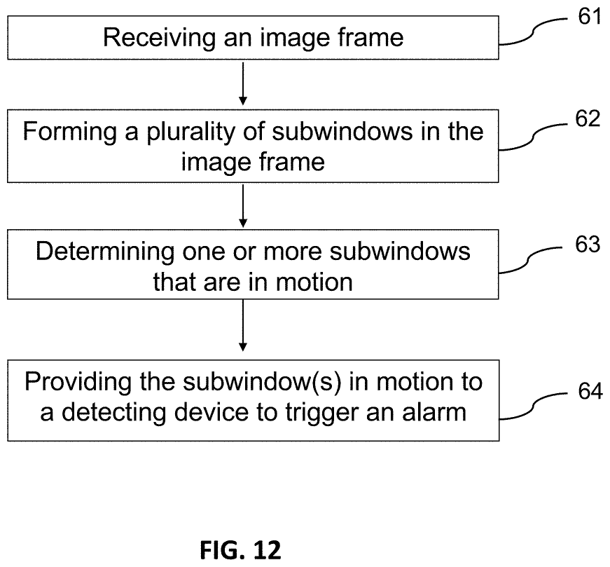

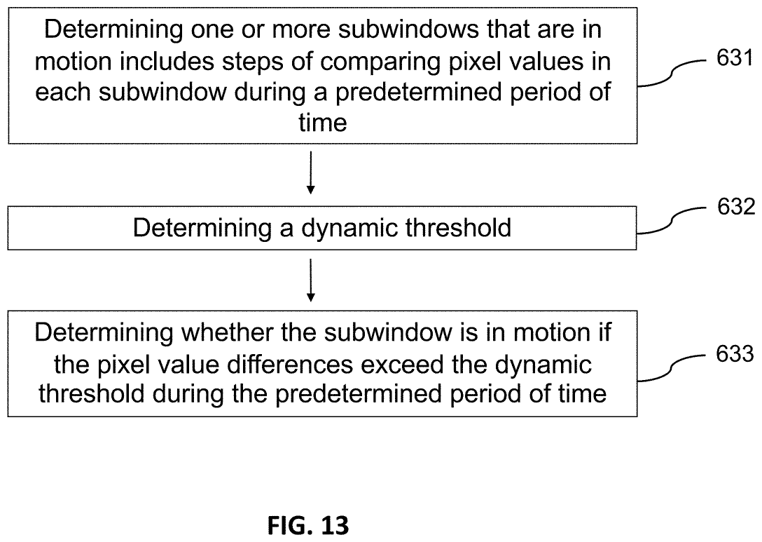

In one aspect, referring to FIGS. 12 and 13, a method for detecting object motion and activity may include steps of receiving an image frame 61; forming a plurality of subwindows in the image frame 62; determining one or more subwindows that are in motion 63; and trigger an alarm after determining at least one subwindow in motion 64, wherein the step of determining one or more subwindows that are in motion includes steps of comparing pixel values in each subwindow during a predetermined period of time 631; determining a dynamic threshold 632; and determining whether the subwindow is in motion if the pixel value differences exceed the dynamic threshold during the predetermined period of time 633.

The step of determining one or more subwindows that are in motion further comprises steps of locating one or more discontiguous set of in-motion regions during a predetermined period of time; obtaining a velocity locus for each in-motion region; grouping two or more in-motion regions with similar velocity loci; and enclosing the in-motion regions with similar velocity loci in a circumscribing rectangle. The method for detecting object motion and activity may further include a step of notifying the user after determining at least one subwindows that is in motion.

In another aspect of the present invention, a system 700 for detecting object motion and activity may include an initial image receiver 710; an image processor 720; a memory 730 and a user interface 740. In one embodiment, the image processor is configured to executing instructions to perform steps of forming a plurality of subwindows in the image frame and determining one or more subwindows that are in motion. The memory 730 and user interface 740 may be operatively communicated with the image processor 720 to perform object motion and activity detection. The result of the object motion and activity detection can be outputted through the user interface 740.

More specifically, the image processor 720 may be configured to generate a plurality of subwindows in an image frame through a subwindow generator 721; and compare pixel values in each subwindow during a predetermined period of time, determine a dynamic threshold and determine whether the subwindow is in motion if the pixel value differences exceed the dynamic threshold during the predetermined period of time through a computing unit 722.

The image processor 720 may also be configured to locate one or more discontiguous set of in-motion regions during a predetermined period of time, obtain a velocity locus for each in-motion region through a velocity locus generating unit 723, group two or more in-motion regions with similar velocity loci; and enclose the in-motion regions with similar velocity loci in a circumscribing rectangle.

It is noted that the initial image receiver 710; the image processor 720; the memory 730 and the user interface 740 can be all integrated into a mobile electronic device, such as a cellular phone. In another embodiment, the system 700 may include a plurality of initial image receivers 710 that can be operated individually and are configured to transmit image frames to the image processor 720 to analyze either through wire or wireless connections.

It is also noted that the sensitivity of the object motion and activity detection system in the present invention can be adjusted. The highest sensitivity can be achieved for a motion detection, namely any movement would be picked up, including shaking tree branches, etc. For example, this kind of sensitivity is needed for a home security system when the home owner is absent and leave his/her dog inside the house.

The user may only need a human motion detection, namely any movement produced from a human look-alike appearance, when the user does not expect indoor movement (e.g. no pets) while being away from home. For mere outdoor uses, the user can change the sensitivity to a suspicious motion detection, namely any movement from point A to point B with sufficient distance in between, which exclude shaking tree.

Comparing with conventional object motion and activity detecting devices, the present invention is advantageous because the computation efficiency for the object motion and activity system significantly increases so the system can even be implemented into a mobile electronic device such as a cellular phone, or a local device such as a camera. Furthermore, the real-time computation can even be done within the mobile or local electronic device without transmitting the computation task to any external devices with much more powerful computation capability.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A method for detecting object motion and activity comprising steps of:
receiving an image frame from at least one detecting device;
forming a plurality of subwindows in the image frame;
determining one or more subwindows that are in motion; and
triggering an alarm after determining at least one subwindows that is in motion,
wherein the step of determining one or more subwindows that are in motion includes steps of comparing pixel values in each subwindow during a predetermined period of time; determining a dynamic threshold; and determining whether the subwindow is in motion if the pixel value differences exceed the dynamic threshold during the predetermined period of time.

2. The method for detecting object motion and activity of claim 1, wherein the step of determining one or more subwindows that are in motion further comprises steps of locating one or more discontiguous set of in-motion regions during a predetermined period of time; obtaining a velocity locus for each in-motion region; grouping two or more in-motion regions with similar velocity loci; and enclosing the in-motion regions with similar velocity loci in a circumscribing rectangle.

3. The method for detecting object motion and activity of claim 1, wherein the detecting device is a cellular phone.

4. The method for detecting object motion and activity of claim 2, wherein the detecting device is a cellular phone.

5. The method for detecting object motion and activity of claim 1, wherein the detecting device is a camera.

6. The method for detecting object motion and activity of claim 2, wherein the detecting device is a camera.

7. The method for detecting object motion and activity of claim 2, further comprising a step of notifying a user after determining at least one subwindows that is in motion.

8. An object motion and activity detection system comprising:
at least one initial image receiver;
an image processor executing instructions to perform: forming a plurality of subwindows in the image frame; and determining one or more subwindows that are in motion; and
a user interface with an alarm that can be trigger if at least one subwindows is in motion,
wherein to determine one or more subwindows that are in motion, the image processor includes a computing unit to compare pixel values in each subwindow during a predetermined period of time; determine a dynamic threshold; and determine whether the subwindow is in motion if the pixel value differences exceed the dynamic threshold during the predetermined period of time.

9. The object motion and activity detection system of claim 8, wherein the image processor executing instructions to further perform: locating one or more discontiguous set of in-motion regions during a predetermined period of time; obtaining a velocity locus for each in-motion region through a velocity locus generating unit; grouping two or more in-motion regions with similar velocity loci; and enclosing the in-motion regions with similar velocity loci in a circumscribing rectangle.

10. The object motion and activity detection system of claim 8, wherein said initial image receiver, said image processor and said user interface are configured to be integrated in a mobile electronic device.

11. The object motion and activity detection system of claim 9, wherein said initial image receiver, said image processor and said user interface are configured to be integrated in a mobile electronic device.
